(19) United States
(12) Patent Application Publication
(10) Pub. No.: US 2007/0156433 A1
(43) Pub. Date: Jul. 5, 2007

(54) Electronic commerce method and system with customizable product displays

(76) Inventors: Eric Thorson, Livermore, CA (US); James L. Koponen, Pleasanton, CA (US)

Correspondence Address: Sean M. Fitzgerald, #342, 3182 Campus Drive, San Mateo, CA, 94403-3123, US

(21) Appl. No.: 11/324,152

(22) Filed: Dec. 30, 2005

(51) Int. Cl. G06Q 99/00

(52) U.S. Cl. 705/1

(57) ABSTRACT

A method and system for presenting customized neon signs is disclosed. Customized signs may be created through entering customized text, selecting a sign style, inserting or deleting icons or other graphical features, entering an image, and choosing the colors of sign features such as text, icons, borders, and the like. The image of a customized neon sign presented simulates the look of a neon sign by applying image effects to simulate the glow and color variation associated with light provided by neon tubing. A cost estimate for a customized neon sign is also presented by calculating the sign price based upon the selected features and their associated prices.

### BACKGROUND

1. Field of the Invention

The field of the invention relates generally to systems for electronic commerce. More particularly, the present invention relates to the field of displaying and selecting customized designs.

2. Related Background

While many items may be purchased over the web using conventional ecommerce sites, many items require specific customization which renders selecting and purchasing such items confusing and certain. Unless an ecommerce site can present an accurate description of the item, the potential purchaser is left with little assurance that the item meets their requirements. This is especially true on items that are intended for public display.

An example of an ecommerce site which provides only limited display and customization is neoncentral.com (www.neoncentral.com). The site has a link to allow visitors to create custom neon signs. The customization area of the site allows lines of text to be added, which are placed in horizontal lines, starting from the top. The entered text is displayed as colored text (the color may be chosen by the visitor), which does not accurately reflect the look and effect of neon tubing. No ability to select other aspects of the sign, from bordering to icons or other images, or any other feature of the sign aside from text, may be chosen. Additionally, the site does not allow custom positioning of text, or adjustment of relative positioning of the text, except as indirectly influenced by the selection of different font sizes.

A second example of an ecommerce site with provides only limited customization is designashirt.com (www.designashirt.com). A visitor to that site may enter text and select artwork for a custom designed T-shirt. Entered text is merely placed on the T-shirt, in a position which generally relates to the center of the shirt (front or back). Images may be added to the shirt, which are similarly positioned. This often results in overlap of the images and text on the shirt image shown to the visitor. It is left to the visitor to alter the relative sizes and positions to create a shirt which has the lettering and artwork positioned in a pleasing manner. Even when the “idea gallery” is used, the site does not allow entered text to replace the placeholder text, as shown in trying to create a custom soccer T-shirt where the placeholder text “your team name” is permanently displayed once the image of the soccer ball is selected. Additionally, putting multiple lines of text and properly positioning them is difficult, at best, given the inability to control different text segments in different ways.

Accordingly, a need exists to provide an efficient and automated system for rendering and displaying customized designs for public display.

### BRIEF DESCRIPTION OF THE FIGURES

FIG. 1 is a generalized block diagram of a computer system that may be used to implement the present invention, according to one embodiment of the invention.

FIG. 2 is a generalized block diagram of a computer system that may be used to implement the customized design rendering portal, according to one embodiment of the present invention.

FIG. 3 is a generalized block diagram of a server computer that may be used to implement the present invention, according to one embodiment of the invention.

FIG. 4 is a generalized block diagram of a neon sign customization page, according to one embodiment of the invention.

FIG. 5 is a generalized block diagram of a neon sign display page, according to one embodiment of the invention.

FIG. 6 is a generalized block diagram of an alternate embodiment of a neon sign customization page, according to one embodiment of the invention.

FIG. 7 is a generalized block diagram of an alternate embodiment of a neon sign display page, according to one embodiment of the invention.

FIG. 8 is a generalized block diagram of an alternate embodiment of a neon sign display page, according to one embodiment of the invention.

FIG. 9 is a generalized block diagram of an alternate embodiment of a neon sign customization page, according to one embodiment of the invention.

FIG. 10 is a generalized block diagram of an alternate embodiment of a neon sign customization and display page, according to one embodiment of the invention.

FIG. 11 is a generalized flow diagram illustrating the process of providing a customized image of a neon sign, according to one embodiment of the invention.

FIG. 12 is a generalized flow diagram of the process of creating a neon sign image, according to one embodiment of the present invention.

FIG. 13 is a generalized flow diagram of the process of creating a neon effect for a customized neon sign image, according to one embodiment of the present invention.

FIG. 14 is a generalized block diagram of an alternate embodiment of a neon sign display page illustrating the neon effect of the customized neon sign image, according to one embodiment of the invention.

FIG. 15 is a generalized flow diagram of the process of creating a customized sign design from tracing an image, according to one embodiment of the present invention.

FIG. 16 is a flow diagram which illustrates the process of determining the price of a customized sign, according to one embodiment of the present invention.

### SUMMARY

The present invention provides for a computer based system and method for presenting, customizing and ordering neon signs. Alternate embodiments allow a potential customer to enter text in for inclusion in a sign, to customize the color, font of the text, to add or remove theme icons or other features for inclusion in a sign, to select, customize or remove a border area for inclusion in a sign, and/or select or modify a style for a sign. The system renders a representation of a neon sign including the text, features and style selected and/or customized by the potential customers. A neon effect may be applied to the entered text, or to other parts of the sign, to give the appearance of neon tubing in a rendered image. In one embodiment customers may receive a price estimate of their customized sign.

### DETAILED DESCRIPTION

The present invention is described in the context of a specific embodiment. This is done to facilitate the understanding of the features and principles of the present invention and the present invention is not limited to this embodiment. In particular, the present invention is described in the context of a web site for displaying and purchasing customized neon signs. The present invention may also be applied to the creation, customization, display, pricing and sale of neon clocks or other items incorporating neon tubing or neon effects, LED signs or other devices incorporating LED elements or LED effects, clocks, mirrors, tap handles, pool table lights, pub signs, wooden signs, light box signs, EL signs, tin signs, automobile graphics, paint or signage, or other forms of displayed items. The example embodiment of a system for designing, creating, customizing, displaying, pricing, ordering and purchasing neon signs is given by way of an example, and is not limiting on the application of the present invention to designing, creating, customizing, displaying, pricing, ordering and purchasing other displayed items.

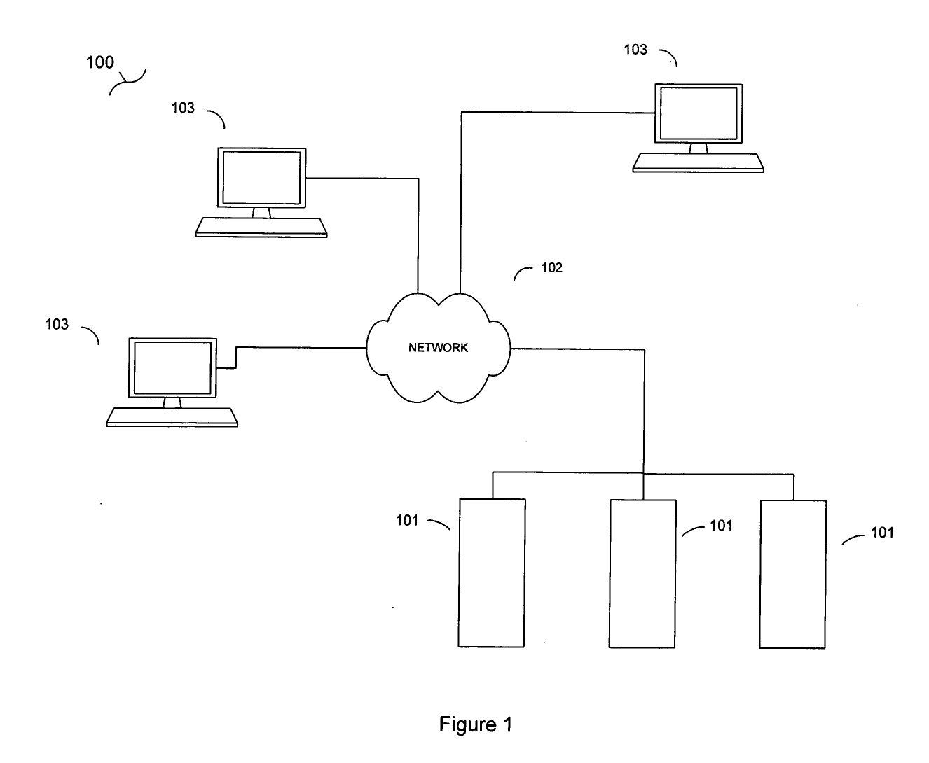

FIG. 1 is a block diagram of a computer system 100 that may be used to implement embodiments of the present invention. Servers from a non-sign portal 101 are connected to a communications network 102. End-user communication devices 103 are connected to the servers of the neon-sign portal through the communications network 102. The servers of the neon sign portal are the servers used to manage the inventory, customized design, presentation and/or sales of an ecommerce web site offering neon-signs.

In the presently preferred embodiment, the end-user communications device is a personal computer. Additionally, in the presently preferred embodiment the communications network is the Internet. Connection to the Internet could be by any form of Internet connection, including broadband and/or wireless connection. Alternatively, a private network or direct link could be established between the business center portal server and the business center servers. Alternatively, the end user communications device could be a mobile phone or any other device capable of receiving graphical messages or images.

The neon sign ecommerce site could be implemented on one single server or on multiple servers. As used in the present application, the term server may refer to a physical computer or to software performing the functions of a server.

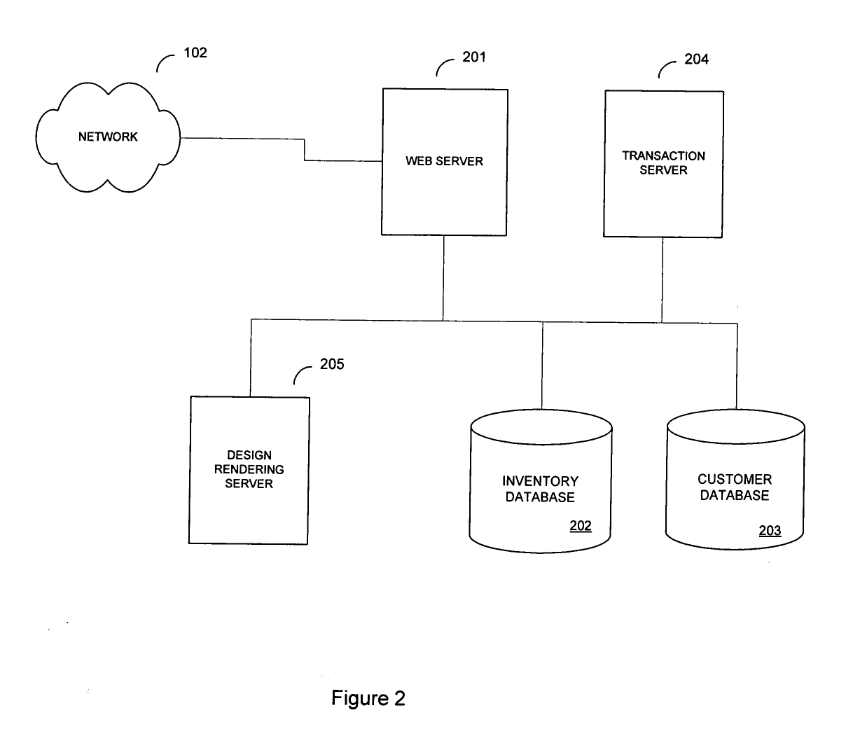

FIG. 2 is a generalized block diagram of the ecommerce site shown in FIG. 1. A web server 201 provides web pages describing the products and services available through a communication network 102. The web server is connected to an inventory database 202, a customer database 203, a transaction server 204 and a design rendering server 205. The inventory database 202 stores information on the types of signs, variations, costs and options offered by the ecommerce site. The transaction server 203 allows potential customers to purchase products or services. The customer database server 204 stores information relating to customers and the products or services they have, designed, customized, requested or purchased. The design rendering server 205 provides the ability for customers to view custom designed products and alter the design of such products.

While the presently preferred embodiment utilizes an inventory database as a separate database from the customer database, alternate embodiments could have utilize one database for both inventory and customer information. Additionally, the information stored within any single database of the presently preferred embodiment could be distributed among several databases in alternative embodiments.

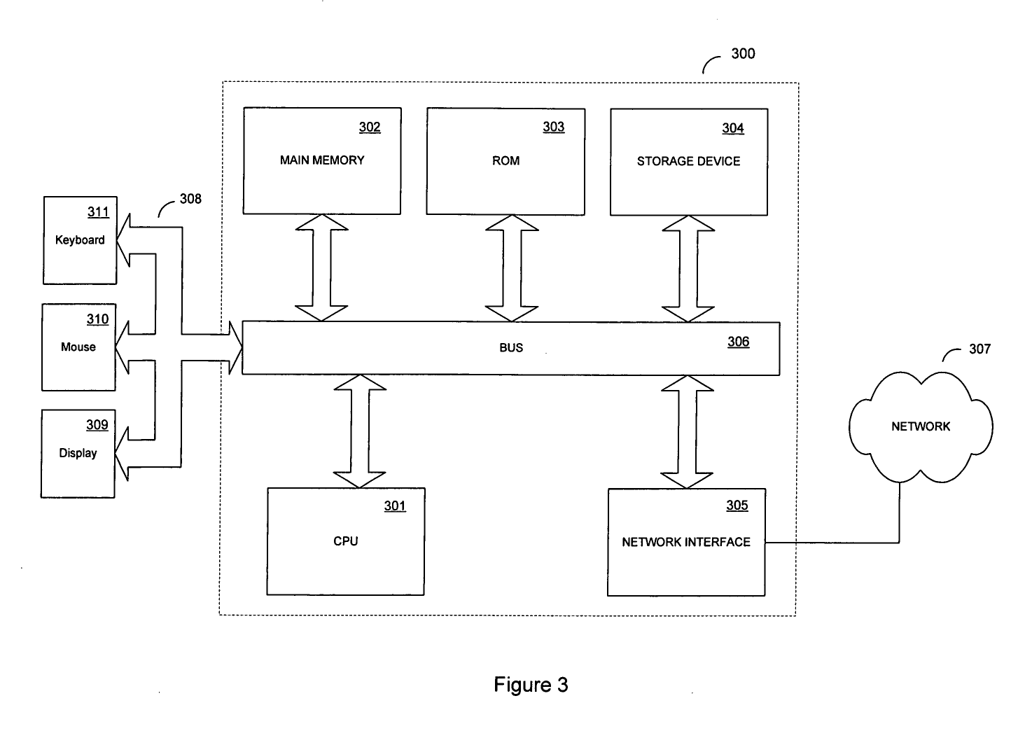

FIG. 3 is a generalized block diagram of a ecommerce server computer 300 including a central processing unit (CPU) 301, main memory (typically RAM) 302, read-only memory (ROM) 303, a storage device (typically a hard drive) 304, and a network device (typically a network interface card, a.k.a. NIC) 305. The network device connects to a communications network 307. The server includes a bus 306 or other communication mechanism for communicating information between the CPU 301 coupled with bus 306. The CPU 301 is used for processing instructions and data. The main memory 302, ROM 303 and storage device 304 are coupled to bus 306 and store information and instructions to be executed by processor 301. Main memory 302 also may be used for storing temporary variables or other intermediate information during execution of instructions to be executed by processor 301.

Server 300 may be coupled via bus 308 to a display 309, such as a cathode ray tube (CRT) or flat panel monitor, for displaying information to a computer user. An input device 310, such as a keyboard, is coupled to bus 308 for entering information and instructions to the server 300. Additionally, a user input device 311 such as a mouse, a trackball, or cursor direction keys for communicating direction information and command selections to the processor 301 and for controlling cursor movement on the display 309 may be used with the server 300.

The server 300 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 301 for execution. Such a medium may take many forms including, but not limited to, non-volatile media, volatile media, and transmission media. Examples of non-volatile media include, for example, optical or magnetic disks, such as storage device 304. Examples of volatile media include dynamic memory, such as main memory 302. Additional examples of computer-readable media include, for example, floppy disks, hard drive disks, magnetic tape, or any other magnetic medium, a CD-ROM, any other optical medium, punch cards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 306 and 308. Transmission media can also take the form of acoustic, electromagnetic or light waves, such as those generated during radio-wave and infra-red data communications.

The end user communication device is similar in general architecture to the ecommerce server.

### Presenting Custom Designed Inventory

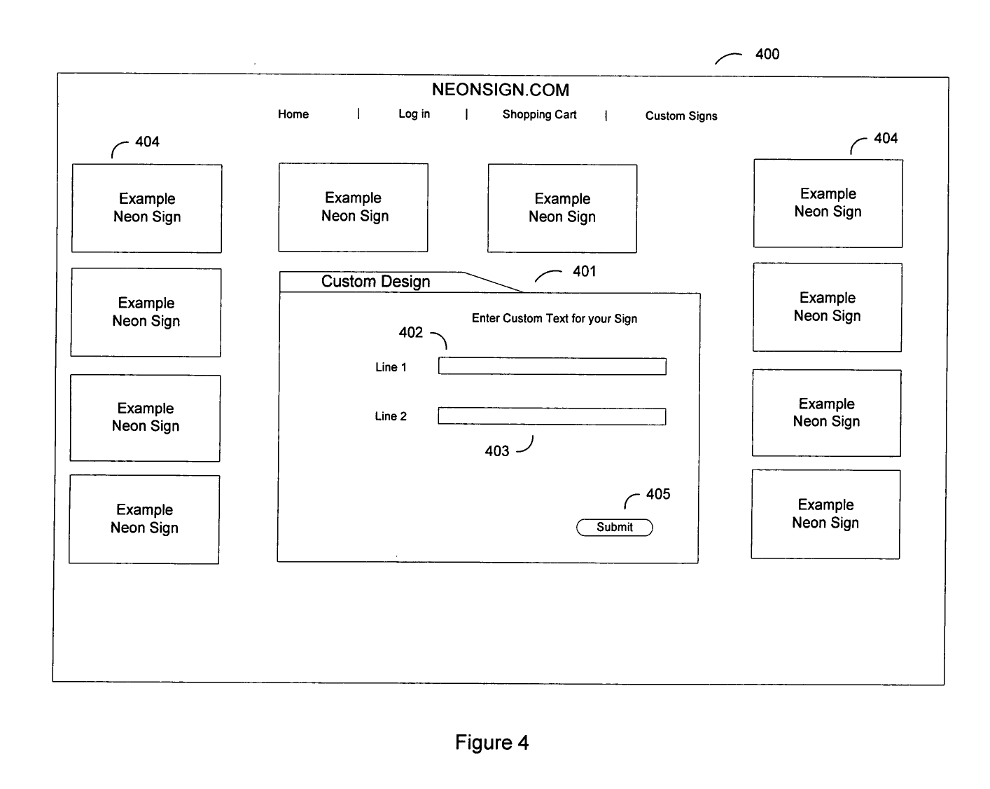

The present invention provides a web accessible portal for visitors to search for, view, design and purchase neon signs. FIGS. 4-10 illustrate the process of presenting, displaying and purchasing custom designed neon signs. In the presently preferred embodiment, the pages shown in these figures are accessible to a potential customer over the Internet using a web browser.

FIG. 4 is a generalized block diagram of a neon sign customization page 400. The neon sign customization page may be the home page of the site, or may be reached from a home page or other page. A customization tab 401 includes a sign text entry field 402. The sign text entry field allows a visitor to enter custom text they would like to see included on a neon sign. A secondary sign text entry field 403 is located below the primary sign text entry field, and allows a secondary text message to be entered by a visitor. In the presently preferred embodiment example neon sign images 404 are included on page 400, and provide the visitor with examples of neon sign designs. The examples may specify different layouts, colors, themes or example messages or text. Once the visitor has entered the text they wish to include in a neon sign they may hit return/enter or click the submit button 405 to move to the customized display page 500. Alternatively, the visitor may click on an example neon sign after entering text in the text field (or fields) to view the entered text in a customized sign with the design they selected by clicking on the example neon sign.

While the neon sign customization page 400 has two text entry fields, alternate embodiments may have more than two text entry fields, or may have only one text entry fields. Alternatively, additional neon sign customization pages may be presented to allow entry of additional or specialized text.

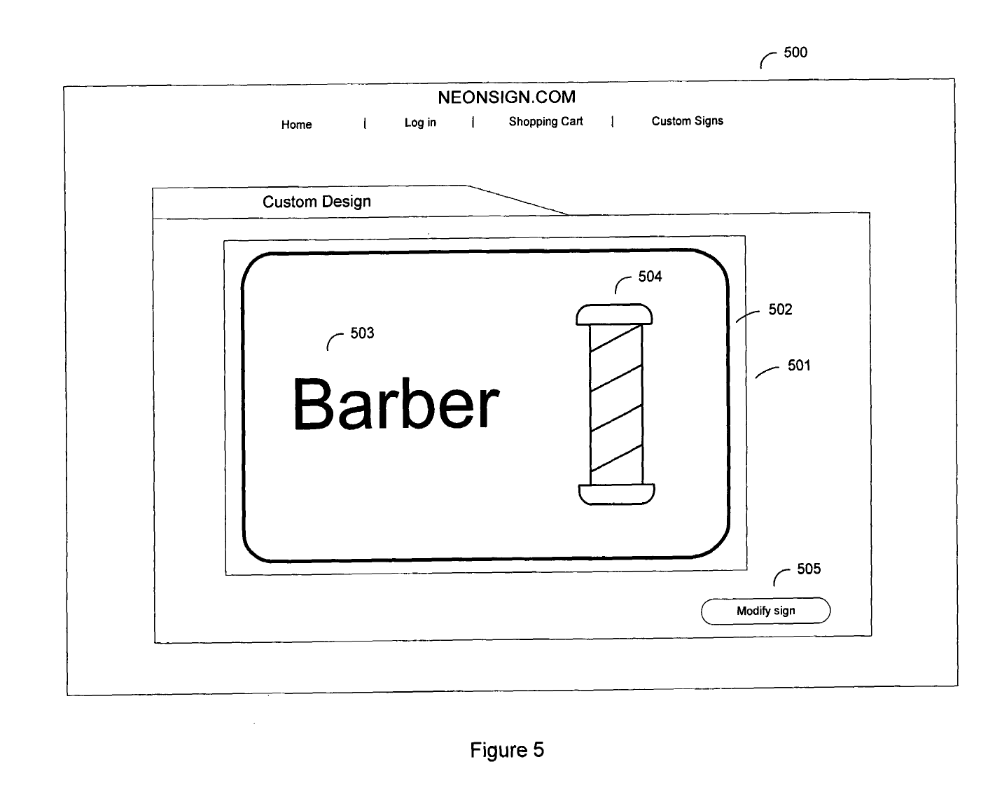

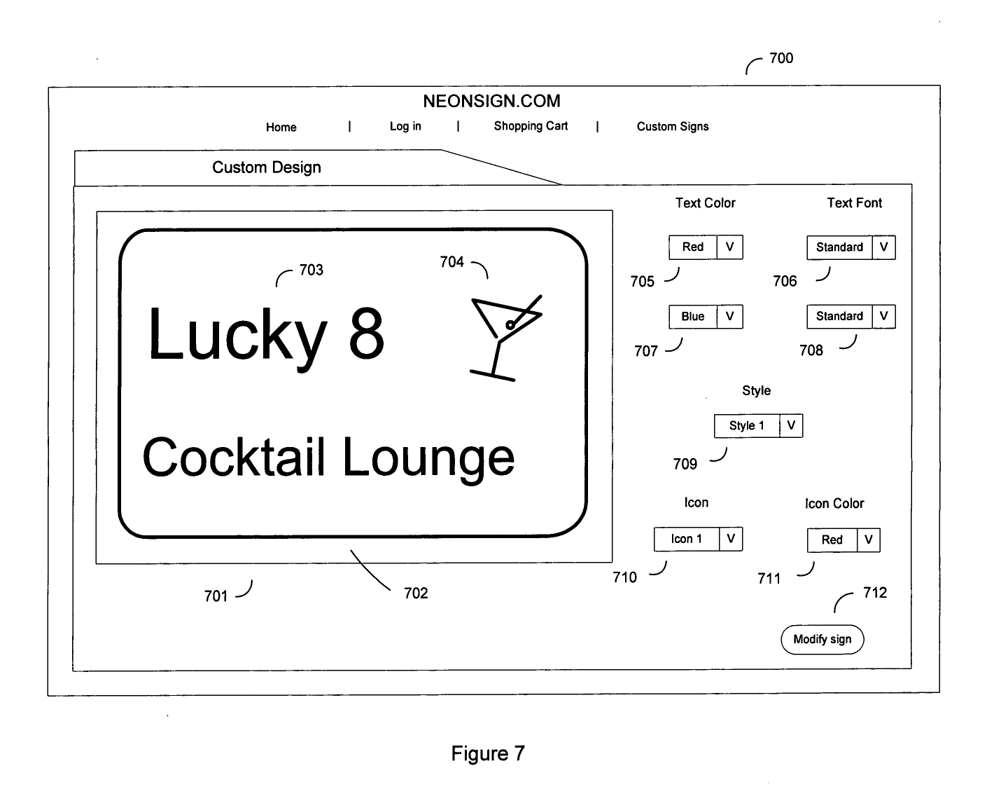

FIG. 5 is a generalized block diagram of a neon sign display page 500. A customized sign display 501 displays an image of a neon sign. The neon sign displayed includes the text entered by the visitor on neon sign customization page 400 described above. Additionally, the entered text is displayed in a manner to convey how the actual neon sign would look if made to the visitor's entered specification, described below in FIG. 7. The example customized neon sign image includes a border area defined by a border tube 502, customized entered text 503, and a theme icon 504. In this example, the theme icon is in the form of a barber pole (as may be used by a barber shop). The customized entered text is placed within the border area in a manner to not overlap, or be overlapped by, the border tube or the theme icon. If the visitor would like to modify the customized sign, the visitor may click on the customized button 505, to be sent to a customization page such as the customization page 400 described above.

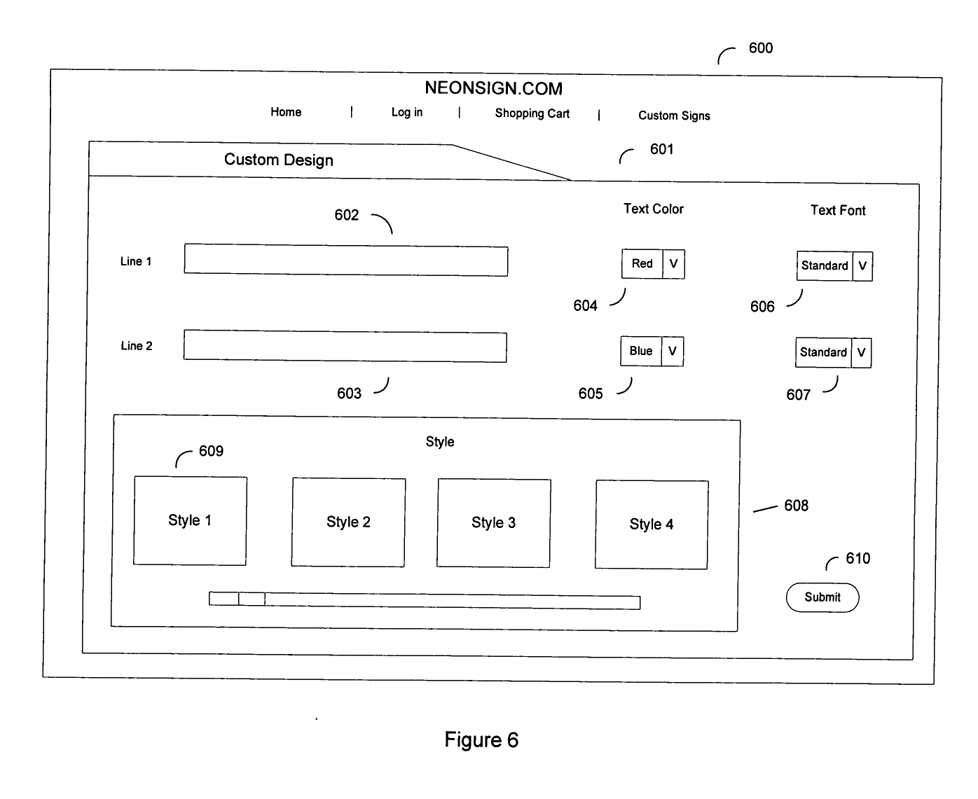

FIG. 6 is a generalized block diagram of an alternate embodiment of a neon sign customization page 600. A customization tab 601 includes a primary sign text entry field 602, a secondary sign text entry field 603 located below the primary sign text entry field, a primary text color selector 604, a secondary text color selector 605, a primary text font selector 606, and a secondary text font selector 607. A style selector 608 provides visitors with the ability to select from among different styles or themes for the sign.

In the preferred embodiment, the color primary and secondary color selectors are drop down boxes providing a list of available colors. Similarly, the primary and secondary text font selectors are drop down boxes providing a list of available fonts. However, alternate embodiments may use control devices other than drop down boxes to allow selection or entry of information used to display a customized neon sign.

In the presently preferred embodiment, the style selector 608 is includes multiple style images 609 which illustrate the available styles for the neon sign. The visitor may select a style for the neon sign by clicking on the style image. As there are many possible styles for a neon sign, the style images may be thumbnails indicating a given style, may be included on a scroll bar the visitor may use to scroll to see additional styles, or may be implemented as style categories, whereby a visitor selects a style category by clicking on the category identifier to view additional examples, or additional identifiers or descriptions, of available styles.

Once the visitor has entered the text they wish to include in a neon sign they may hit return/enter or click the submit button 610 to move to a customized display page such as display page 700 discussed below.

FIG. 7 is a generalized block diagram of an alternate embodiment of a neon sign display page 700. A customized sign display 701 displays an image of a neon sign. The neon sign displayed includes the text entered by the visitor on neon sign customization page 600 described above. Additionally, the entered text is displayed in a manner to convey how the actual neon sign would look if made to the visitor's entered specification including the color, font and style specified in page 600 by the visitor, described above relation to FIG. 6. The example customized neon sign image includes a border area defined by a border tube 702, customized entered text 703, and a theme icon 704. In this example, the theme icon is in the form of a cocktail glass (as may be used for a bar or cocktail lounge). The customized entered text is placed within the border area in a manner to not overlap, or be overlapped by, the border tube or the theme icon.

In the presently preferred embodiment, the customized sign display page 700 also includes customization controls 705-711. The customization controls allow the visitor to modify the image of the neon sign shown in the customized sign display 701. In the presently preferred embodiment, the customization controls include a primary text color sector 705, a primary text font selector 706, a secondary text color sector 707, a secondary text font selector 708, a style sector 709, a theme icon selector 710, and a theme icon color selector 711. The visitor may change the specifications for their customized sign and click on the submit button 712, which then updates the image of the neon sign shown in the customized sign display 701 to reflect the changed neon sign specifications.

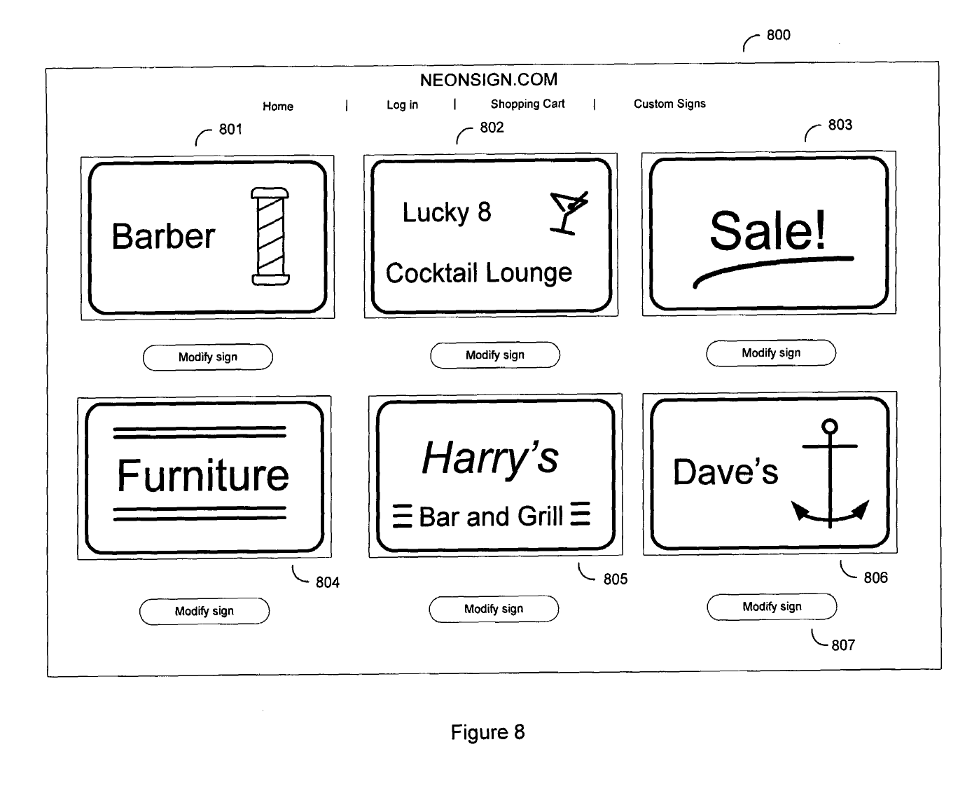

FIG. 8 is a generalized block diagram of an alternate embodiment of a neon sign display page 800. A plurality of customized sign display images 801-806 display neon signs. In the presently preferred embodiment, the neon sign (or signs) displayed includes the text entered by the visitor on neon sign customization page such as page 400 described above. In the presently preferred embodiment, the customized images provide the visitor with a customized sign in a given style. For example, image 801 displays a barber themed style, image 802 displays a cocktail lounge style, image 803 displays a style with an accent underlining the primary text, image 804 displays a style with accent bars, image 805 displays a style indicating a bar and grill with accent bars, and image 806 displays a style with an anchor indicating a nautical theme. As with the preceding display pages, the entered text is displayed in the neon sign image in a manner to convey how the actual neon sign would look if made to the visitor's entered specification, described below.

Below each customized sign display image 801-806 is a customization button 807. By clicking on the customization button the visitor is brought to a page which allows the visitor to select variations to further customize the neon sign displayed in the customized sign display image associated with the customization button. The visitor may either be presented with a page similar to page 800, which presents images illustrating different variations of the style, such as different colors for texts, borders, or icons, different fonts, or variations in the placement of text or icons within the theme of the style, or with a page similar to page 700 which provides controls to modify aspects of the neon sign.

If the visitor would like to modify the customized sign, the visitor may click on the customized button 807, to be returned to a customization page such as the customization page 400 described above.

Additionally, the neon sign display page 800, or other embodiments of neon sign display pages, pay include a purchase, or add to cart, button or similar control to allow a visitor to select a sign for purchase, ordering or addition to their shopping cart, wish list, etc.

While the preferred embodiment utilizes a customization page like page 800, where a prospective customer selects a style to customize on a page like page 700, the style selection page may include customization controls where the style is modified (partially or completely) without having to go directly to a separate style customization page.

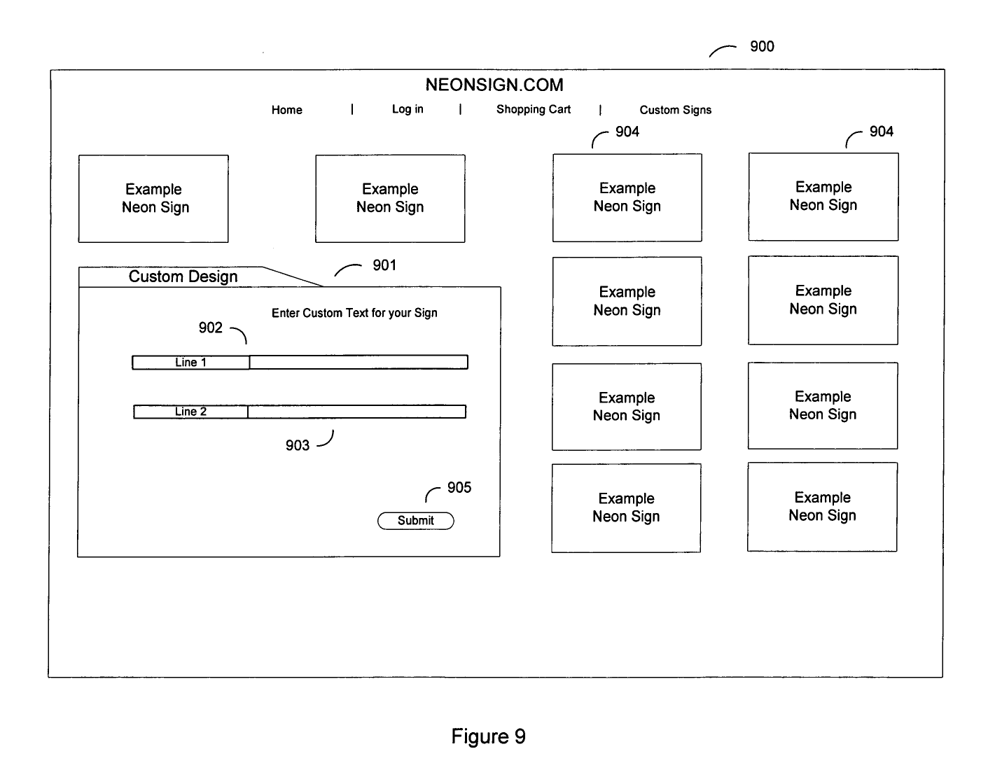

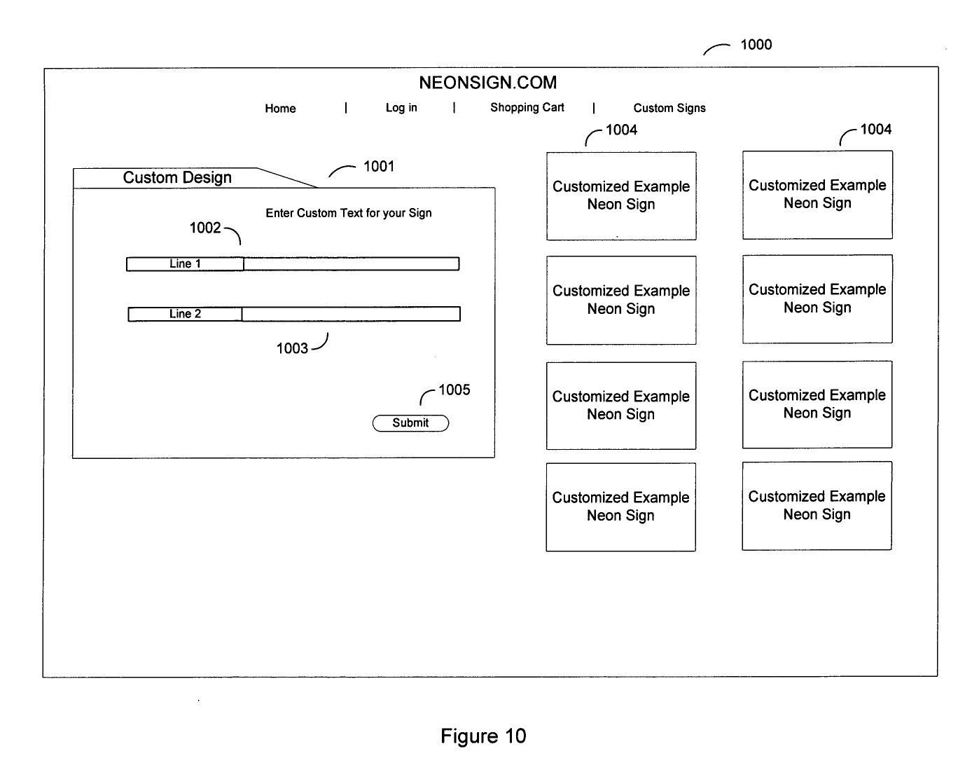

FIG. 9 is a generalized block diagram of an alternate embodiment of a neon sign customization page 900. A customization tab 901 includes a sign text entry field 902. The sign text entry field allows a visitor to enter custom text they would like to see included on a neon sign. A secondary sign text entry field 903 is located below the primary sign text entry field, and allows a secondary text message to be entered by a visitor. Multiple style images 904 which illustrate the available styles for the neon sign may be included on page 900. The visitor may select a style for the neon sign by clicking on the style image. Once the visitor has entered the text they wish to include in a neon sign they may hit return/enter or click the submit button 905 to move to a customized display page such as the page illustrated in FIG. 10 and described below, or alternative embodiments of the neon sign display pages described herein.

FIG. 10 is a generalized block diagram of an alternate embodiment of a neon sign customization and display page 1000. A customization tab 1001 includes a sign text entry field 1002. The sign text entry field allows a visitor to modify or enter custom text they would like to see included on a neon sign. Similarly, a secondary sign text entry field 1003 is located below the primary sign text entry field, and allows a secondary text message to be modified or entered by a visitor. Multiple customized neon sign images 1004 which illustrate the available styles for the neon sign may be included on the neon sign customization tab 1001 of page 1000. The multiple customized neon sign images present the visitor with different variations of neon signs incorporating the text entered by the visitor on a customization page, such as the customization page 900 shown in FIG. 9, or alternate embodiments of neon sign customization page, or from prior entry into the neon sign customization and display page 1000. In the event a visitor had previously specified a style, the multiple customized neon sign images may present the visitor with variations within a style, such as variations in color, layout, text font, text placement, or any other variations on the selected style. In the event a visitor had not selected a style, the multiple customized neon sign images may present the visitor with different styles, including several styles and variations within the styles, for selection. Additionally, one of the presented multiple customized neon sign images may be highlighted as the selected image, such as the customized sign image most closely representing the selections by the visitor, or a popular choice corresponding to the selections by the visitor,

The visitor may select a style for the neon sign by clicking on one of the multiple customized neon sign images Once the visitor has modified or entered the text they wish to include in a neon sign, or selected a style or variation on a style, the visitor may hit return/enter or click the submit button 1005 to view the changes or selection on a customized neon sign display page.

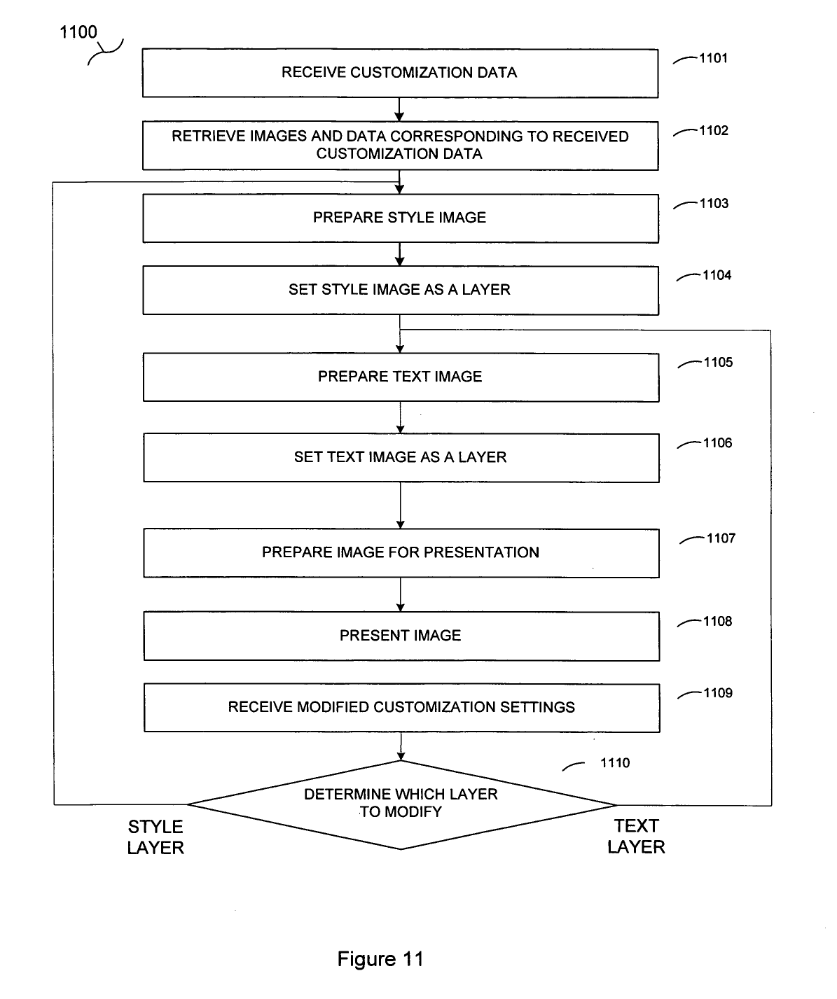

FIG. 11 is a generalized flow diagram illustrating the process 1100 of presenting a customized image of a neon sign. At step 1101 the system receives the neon sign customization parameters. The received customization parameters could have been entered by a visitor on a page such as page 400, 600, 900 or page 1000 shown above in connection with FIGS. 4, 6-10 respectively. At step 1102 the system retrieves selected images and data from an image customization database. The retrieved images may include images of a given style or icon, and may also include images of text. As an example, if the visitor has selected a given style, a “blank” style image may be retrieved that already has the border and style elements (or style features or style components), but which does not include text in the custom text area of the neon sign (but may include text associated with the style). The custom text area of the neon sign is the portion of the sign designated to allow a visitor to add their customized text.

The retrieval of images and data corresponding to the neon sign customization parameters at step 1102 may include stored images or templates to be used in creating images for the neon sign image to be presented. For example, if the neon sign customization parameters specify a particular style, the system may retrieve a stored style image and style template. The style image may contain elements or features of the style, such as a border, text, or icons included within the style. As there may be multiple ways to customize a sign within a style, by varying the size, position, color and number of elements of the style such as the text, icons and borders within a style, the customization parameters may specify one image containing all of the style elements, or may specify multiple images which, collectively, contain all or some of the style elements, including optional style elements and/or custom features unrelated to the style. As stated above, the system may retrieve a style template. Style templates may include information used by the system to generate an image (or images) from the entered custom text. Templates may specify letter sizing and text positioning information, as well as text font or color information. For example, a template for use with the barber shop style may specify the custom entered text is to be displayed across a line, which is at a given angle from the horizontal, and preferably be positioned within (or at) a set of pre-defined coordinates, and wherein the custom entered text is to be sized to fit the area defined by the preset coordinates, and the custom entered text is to be written with a pre-specified font according to a color specified in the customization parameters. Thus, the template provides the system with information sufficient, when combined with the customization parameters, to create a custom image text image (or images), which may be layered with other images, such as a style image, to create the customized neon sign.

At step 1103 the system prepares the style image. Preparation may include retrieving a stored style image from a library of style images, or may involve the creation of a style image based on the received customization parameters. The preparation may also involve additional processing, including resizing, conversion to different file formats, or image processing to alter or enhance aspects of the style image.

At step 1104 the prepared style image is set as a layer for the customized neon sign image. At step 1105 the system prepares the text image to be used in creating the customized neon sign image. The text image may include some or all of the text for the customized neon sign, or may contain additional elements relating to the style or visual effects of the customized neon sign image. As there may be multiple additional images combined to create the customized neon sign image, step 1105 may involve the preparation of multiple images.

At step 1106 the system sets the image from step 1105, which may include the customized text specified in the received customization parameters, as the next layer in the customized sign image. As there may be multiple additional images combined to create the customized neon sign image, step 1106 may involve the setting of multiple images as layers of the customized neon sign image.

Note, while step 1105 involves the preparation of images and step 1106 involves the setting of images as a layer in the customized neon sign image, when there are multiple images, some or all of the images may be prepared before setting the images as a layer, or one or more prepared image may be set as a layer before preparing one or more additional images.

At step 1107 the system processes the customized sign image in preparation for presenting the image. The pre-presentation processing may include resizing the image, compression or decompression of the image, changing the file format of the image, color balancing, manipulation or shifting of the image, or other processing to aid in downloading and image to a potential customer's computer and presenting the image to the potential customer. In the preferred embodiment, the processing involves any pre-presentation processing of the customized neon sign image including all the added image layers. In alternate embodiments, the system may involve image processing of a subset of layers prior to the inclusion of certain layers in the customized neon sign image.

Preparing the image for presentation may also include adding, removing or altering visual effects, as described below, to enhance the neon effect to better approximate the appearance of a neon sign to the potential customer.

At step 1108 the system presents the customized non sign image to a potential customer. In the preferred embodiment, this is done by presenting the image within a web page such as the page illustrated in FIG. 7 or 8.

After presenting the image the system may receive modification settings to the customized neon sign image at step 1109. For example, a potential customer, having seen the customized neon sign they specified in step 1101, may wish to change an aspect of the customized neon sign. The aspect changed may involve the custom entered text, by adding, deleting, or both adding and deleting text, or may involve one or more aspects of the style including the icon, color, theme, border, or other aspects of the style.

At step 1110 the system determines which layer or layers are impacted by the received modification settings. If the modification settings involve the style layer, the system returns to step 1103 where a new style image will be prepared in accordance with the original customization parameters as modified by the modification settings. If the modification settings specify a layer other than the system layer, the system proceeds to step 1105, where a new image (or images if more than one image is impacted by the modification settings) will be prepared in accordance with the original customization parameters as modified by the modification settings. Note, the modification settings may involve deletion or addition, or both, or one or more images. Accordingly, the system combines the modified images with the unmodified images, processes the modified customized neon sign image, and presents the image at step 1108.

### Creating a Customized Neon Sign Image

The presently preferred embodiment provides for the ability to present to a potential customer an image which approximates the look of a neon sign. The present embodiment also provides for presenting an image for customized designs.

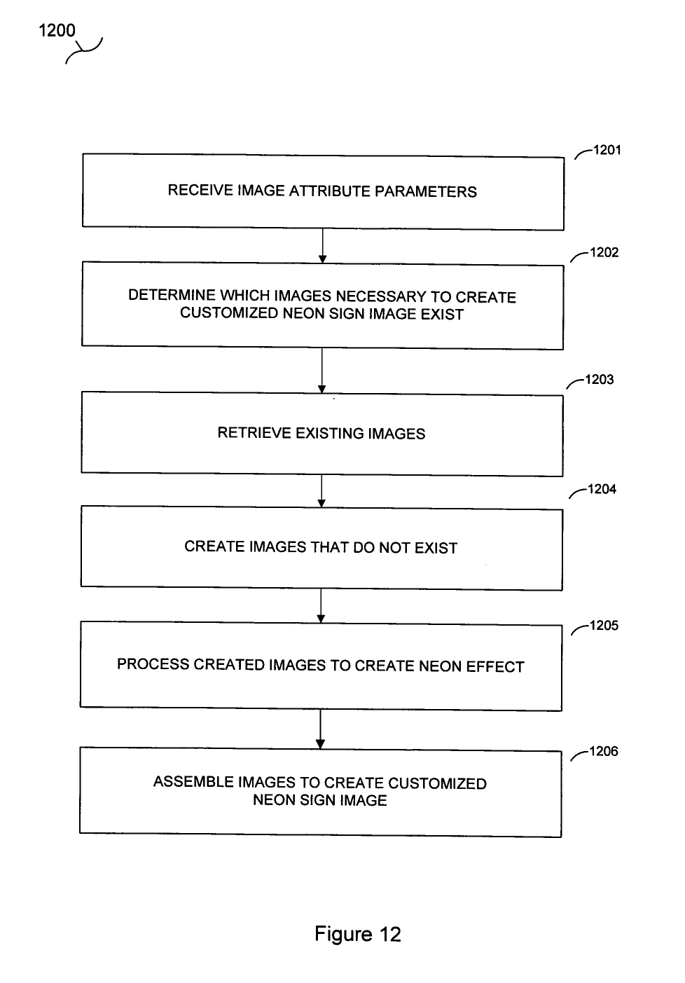

FIG. 12 is a generalized flow diagram of the process 1200 of creating a neon sign image. At step 1201 the system receives image attribute parameters. The image attribute parameters may be received from a prospective customer through a browser, from a database, or from any other source. The image attribute parameters may include any feature or aspect of a neon sign, including the number of tubes, the color of the tubes, the shape of the tubes, the number, location and/or size of the bends in a tube or tubes, a given icon formed a tube or tubes, a given icon size, color or orientation, lettering formed from a tube or tubes, lettering size, color or orientation, or other parameters specifying features or aspects of the neon sign.

At step 1202 the system determines which images required to create a customized image according to the received image attribute parameters. Images such as style images, icon images, text images, and the like may be stored for later retrieval to compose a customized neon sign image, as described above in connection with FIG. 11.

At step 1203 the system retrieves the images determined to exist in step 1202. In the presently preferred embodiment, the stored images already include the necessary visual effects to create the neon tubing effect. However, alternate embodiments could have one or more stored images that do not possess the visual effect necessary to simulate the look of neon tubing. In such an embodiment, the present invention may process such images to include the neon effects in such images

At step 1204 the system creates the images required to create the customized neon sign image according to the received image attribute parameters which were not determined to exist at step 1202. The process 1100 described above may be used to create the image or images at step 1204.

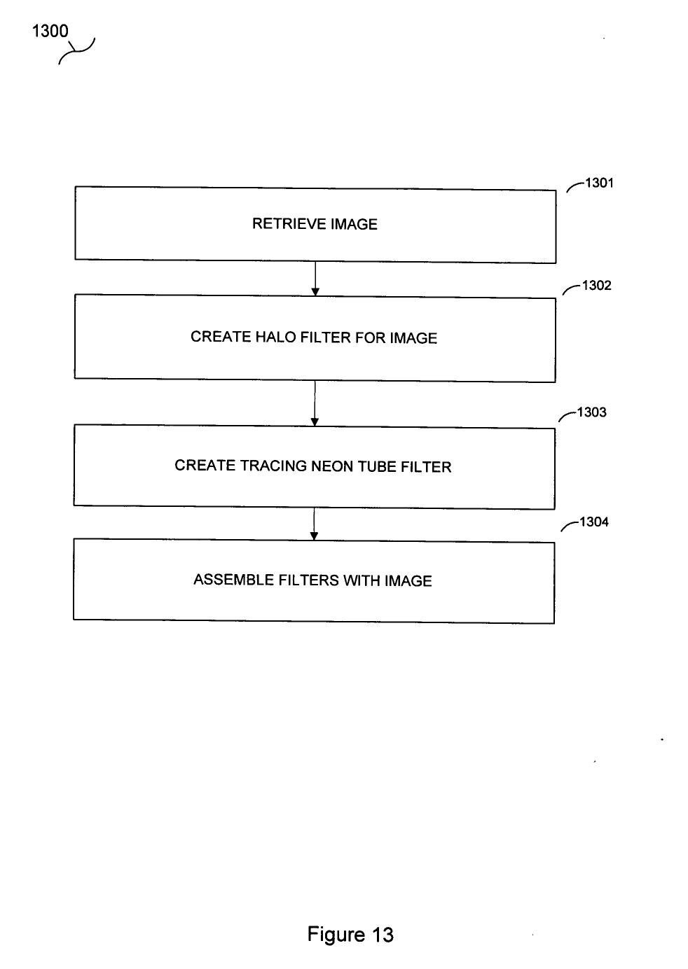

At step 1205 the system processes the images created at step 1204 (and in alternate embodiments any stored images that do not include the desired neon effect) to create the neon effect. The process used to create the neon effect is described below in connection with FIG. 13.

At step 1206 the system assembles the images processed to exhibit the neon effect at step 1205, and the retrieved images from step 1203, to create the customized neon sign image according to the received image attribute parameters. An example of the process used to assemble images to create the customized neon sign image is described above in connection with process 1100 illustrated in FIG. 11.

In this manner the system is able to provide “real time” customization and feedback to a potential customer. After entering the text or selecting sign features, the system presents a customized image of a neon sign according to the specific customization parameters entered or chosen by the potential customer. Additionally, the potential customer may modify the entered or selected customization parameters to further refine and customize the sign before making a purchase decision. In this manner the potential customer is able to design a neon sign that suits their needs and preferences, and view images which give the potential customer information on how their sign would look once constructed, in an automated fashion.

### Creating a Neon Effect

To aid potential customers in visualizing how their sign will look in real life, the present invention provides a neon effect when presenting the custom designed sign. Standard HTML pages allow text to be presented in many different colors and styles. While this provides a wide range of options for presenting text, they do not provide the “look” of a neon sign. While images of actual neon signs presented on a web page may convey the look of a neon sign, as it is not possible to anticipate the infinite number of variations potential customers may want in a neon sign, images of actual neon signs are inadequate for both presenting a customized sign and providing the customized sign which has the appearance of a neon sign. To accomplish this, and give the potential consumer the impression that they are looking at a neon sign, the present invention combines several visual effects to simulate the neon effect.

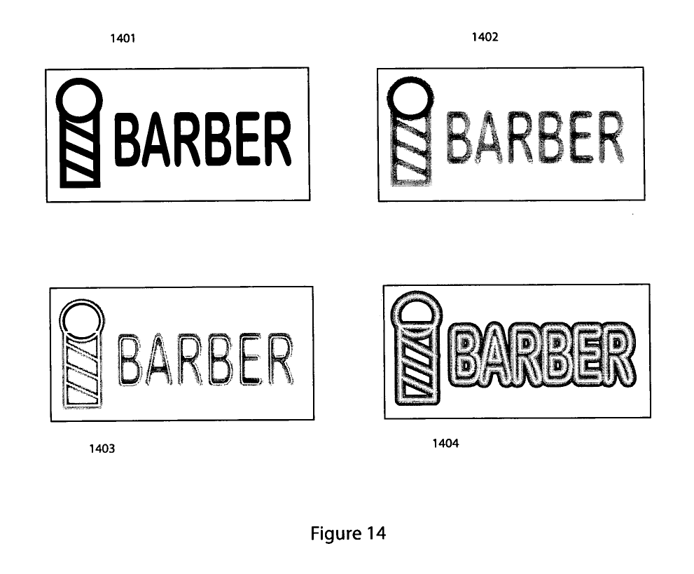

FIG. 13 is a generalized flow diagram of the process 1300 of creating a neon effect for a customized neon sign image. At step 1301 the system retrieves a first image for use in creating the neon effect customized sign. The first image 1401, as shown in FIG. 14, includes at least one image feature, such as an icon or text, which is common to the desired features of the customized sign. The image feature of the first image has a given color. Example colors include red, green, blue, yellow, etc.

At step 1302 the system creates a filter of the first image. At step 1303 filter of the first image is modified to create a “halo image” of the image feature of the first image. The halo feature is a dispersion of the color of the image feature beyond the image border of the image feature. The dispersion reduces the color density, producing a translucent halo image in the same shape as the image feature of the first image. The halo image may be a tracing, and the color either dispersed to be wider than the line width of the image feature of the first image. Alternatively, the filter may be made from a copy of the first image, and the image feature is dispersed to create the halo image. The dispersion may be produced by transforming the trace line, or other line, from opaque to translucent. In the presently preferred embodiment, the halo image is done in the same color as the text or sign feature. If an image 1401 has multiple colors, different halo effect layers may be created for each color, or multiple colors may be included in a single halo effect layer. The halo image lines may be of uniform color density, or the color density of the halo image lines may vary. For example, the halo image line may have a color gradient which decreases, or fades, the color density (or increases the translucence of the halo image line) at points of the line further from the center axis of the halo image line.

At step 1303 the system creates a white tracing of the image feature of the first image. The white tracing is done in a thinner line width, or font, such that when the white tracing filter is overlay the original image only the center portion of the image feature will be obscured by the white tracing filter. (Note, that while the presently preferred embodiment uses white as the tracing color, other embodiments could use other colors for the tracing color.) Similar to the font and lines used for text and other features, in the preferred embodiment the tracing is done in a constant width font or line.

At step 1304 the system assembles the first image and filters to create the customized neon sign image. The filters, both the halo effect filter and the center tracing filter, are aligned with the image feature of the first image. In the event the first image does not already include a background, or if the background is not the appropriate color, a background layer may also be included in the assembled image. The assembled image may be stored for future use, or may be presented to a potential customer. The stored assembled image may be stored as a single image file, or as multiple associated image files.

Process 1300 may be repeated for any or all of the images that are included in creating a customized neon sign image, as described above in connection with FIGS. 11 and 12.

While the example embodiment described above in connection with FIG. 13 used a halo effect layer and a white center tubing layer, alternate embodiments could use additional effects, either in the same layers or in additional layers, to create the customized neon sign image.

The processing of images to create a neon effect may also include use of optical character recognition (OCR) technologies to discern text, which may then be used to create a center tubing layer, halo layer, or other effects. Additionally, OCR may be used to allow a visitor to uplink an image which may be read and input into a customized neon sign, including the creation of neon effects, altering text size, spacing, format or placement, or other similar transformations to aid in creating a customized neon sign image.

FIG. 14 is a generalized block diagram illustrating the different visual effects used to create the effect of viewing a neon sign. An image which has no special neon effects applied to it or included in it, as shown by image 1401. As discussed above, a “halo effect” image is created, as discussed above, which is a dispersion of the color of the image feature beyond the image border of the image feature, as illustrated by image 1402. The “halo effect” gives the appearance that the lines of the image have been blurred. In the present example the effects images are based upon the original, unmodified image 1401.

A center tube tracing image, whereby a centerline is created to overlap the colored portions of the original image to give the effect of a glowing neon tube, is illustrated by image 1403. In the presently preferred embodiment, the centerline is white to aid in the illusion that the image actually represents lit neon tubing. The combined image is shown at 1404, with the “halo” and “white centerline” representing the neon effect seen in neon tubing.

### Tracing To Create Custom Designed Inventory

It can be a difficult process to master the ability to create a design using the interface of the typical personal computer having a keyboard and mouse. While graphics designers and others have mastered this skill, many computer users have not. To aid potential customers in creating their own designs for a neon sign, and

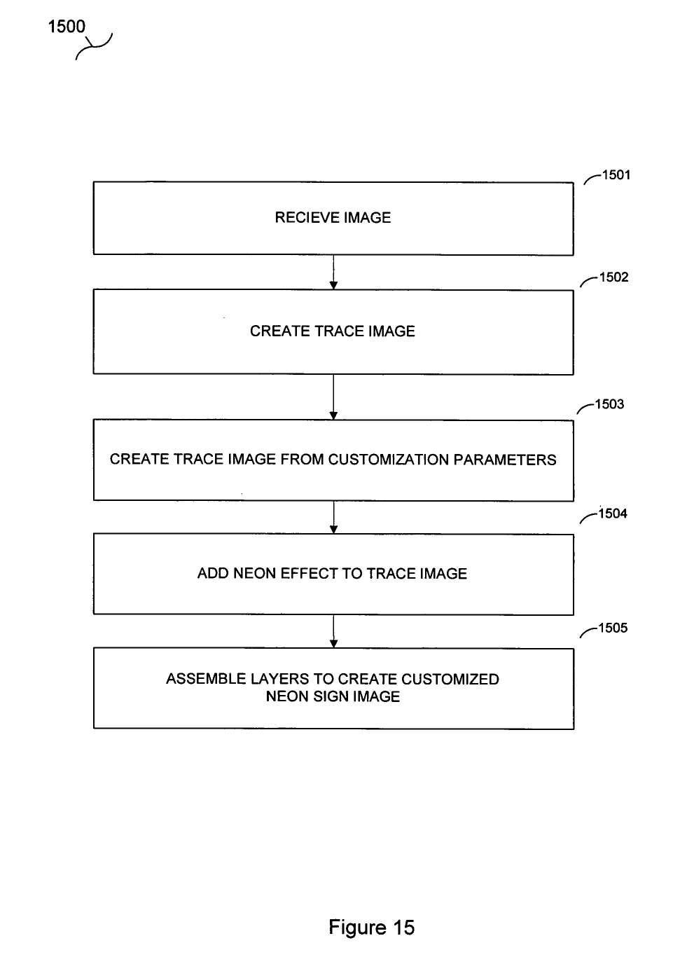

FIG. 15 is a generalized flow diagram of the process 1500 of creating a customized sign design from tracing an image. At step 1501 the system receives and image to be used as the trace image. The trace image need not be an actual image of a sign, and may only approximate the design the potential customer is seeking to create. Also, the trace image may only include a portion of the desired features of the customized sign, or only a portion of the trace image may be of use or interest to the potential customer.

At step 1502 the system creates a trace image from the received image. In creating the trace image, the system determines the essential coordinates of the tracing image. For example, the tracing image will have a fixed number of lines, these lines have a beginning and end coordinates, and the lines may include curves or bends. The essential coordinates of the trace image are set as customization parameters.

The trace image may be in color, or it may be colorless, from the perspective of the system. That is, the tracing step 1502 may also determine the colors of the lines, which are then included in the customization parameters. Alternatively, if the system is unable to determine the color of one or more lines, or if the color of the lines or lines is left to later selection/customization, the system may treat the lines as colorless. Additionally, the system may assign a default color to lines (including different default colors to different lines) or may suggest a color for a given line or lines.

At step 1503 the system creates at least one neon sign trace image based upon the customization parameters determined at step 1502. As the trace image may include multiple lines, the system may limit the number of lines in a neon sign trace image, or include all the lines in a single neon sign trace image. In creating the neon sign trace image the presently preferred embodiment of the system, as described above, uses a line with or font of a constant thickness (or near constant thickness) to approximate the look of a neon tube. In creating the neon sign trace image the system may introduce effort correction or approximation effects. For example, the traced image may include a line drawn to a circle, which the system may correct to a proper circle. Other corrective effects may eliminate wiggles or other defects in the lines of the trace image, to improve the aesthetics of the customized neon sign. Additionally, the lines of the trace image may involve curves or bends which can not be made in neon tubing, or can not be easily made in neon tubing. The system may then produce lines in the neon sign trace image which approximate the lines of the trace image, but substitute or correct for the difficult or impossible line features of the trace image.

At step 1504 the system processes the neon sign trace image (or images) to include the neon effect, as described above in connection with FIGS. 11 and 12.

At step 1505 the system assembles any images or layers to create a customized neon sign trace image. The customized neon sign trace image may then be presented to a potential customer, or saved for future reference.

As discussed above, OCR technology may also be combined with image tracing to create a customized neon sign image.

### Pricing and Presenting Custom Designed Inventory

The present invent allows a visitor to both design and purchase a custom designed neon sign. One aspect of that process is providing the visitor with a price quote for the custom sign. Given that the visitor may choose to go to another vendor if they receive a better price quote elsewhere, it is a benefit to provide a price which reflects the true cost of manufacture of the custom designed sign. Accordingly, the present invention provides a price quote on a custom designed neon sign based on the custom design specifications entered by the visitor.

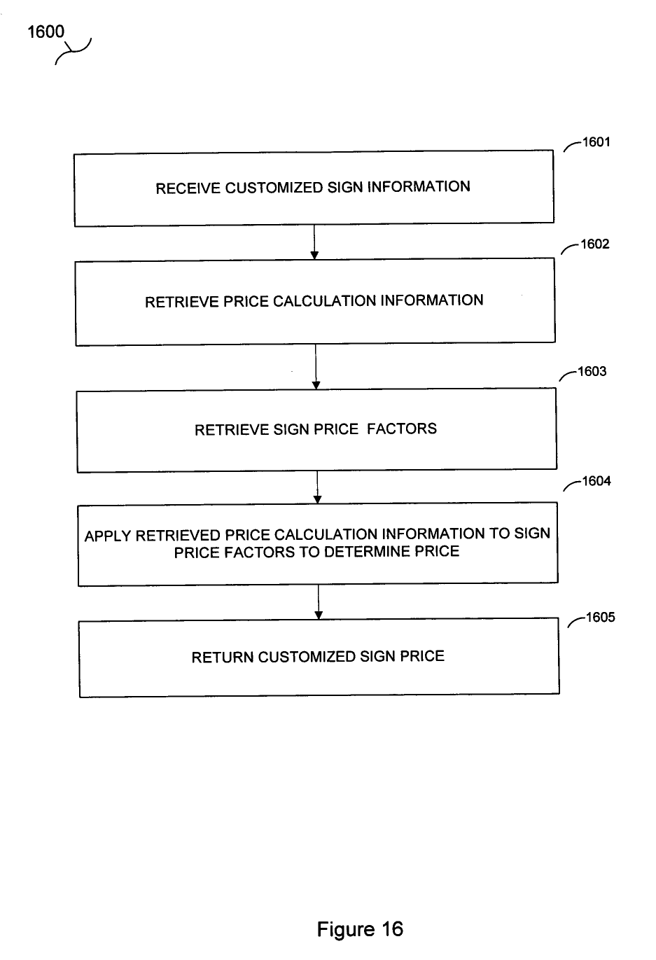

FIG. 16 is a flow diagram which illustrates the process 1600 of determining the price of a customized sign. At step 1601 the system receives customized neon sign design information. In the preferred embodiment, the customized neon sign design information includes the proposed layout, including the number of neon tubes, the length and size of the tubes (and may also include the color of the tubes). The customized sign design information may also include information on the bends in the neon tubes. For example, the neon tube bend information may include the number of bends, the radius of the bend, the direction of the bend, the proximity of a bend to another bend (on the neon tube which has that bend or on another neon tube), or any other information which may impact the complexity of the manufacture of the customized sign.

At step 1602 the system retrieves from the customized sign design information the information to be used in calculating the price of the sign. For example, a base price for all signs may assume a border neon tube and a lettering tube (or a preset number of lettering tubes). In such an example, the system retrieves information to determine the number of neon tubes not included (or not covered) in the base sign price.

At step 1603 the system retrieves the sign cost factors from a database. In the presently preferred embodiment, the sign cost factors retrieved at step 1603 relate to the customized sign design information retrieved at step 1602.

A step 1604 the system applies the retrieved the sign cost factors to the retrieved customized sign design information to determine a sign price.

At step 1605 the system returns a customized design neon sign price.

Below is an example of the application of a customized sign price determination.

### Price Calculation Example

With sign cost factors:
base sign cost: $100.00 including: sign frame border tube primary lettering tube (up to six letters)
secondary lettering tube cost $30.00
lettering tube cost in excess of three $20.00
lettering tube surcharge with more than six letters: $7 per letter
tube bends in excess of five $5.00 each
selected icon: $50.00
custom icon (single tube, eight bends or less): $140.00
additional bends per icon in excess of eight): $20.00

Applied to a sign with customized sign design information:
sign frame, border tube, primary lettering tube (five letters), secondary lettering tube (seven letters), custom icon (with ten bends),

The cost of the customized sign is calculated as:

Cost=base cost+secondary letting tube cost+secondary lettering tube surcharge+custom icon cost+custom icon surcharge

Substituting the example prices and costs:

Cost=$100+$30+$20 (1 additional letter)+$140+$20 (2 extra bends)=$330

As the above example shows, the customized sign parameters, which are used to create the image, may be used to provide the potential customer with a customized price quote for the neon sign.

While the above embodiments were described in the context of web accessible pages viewed through and internet browser, alternate embodiments could use other technologies or client side agents, to provide access to the pages and functionality described in the present application.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method of presenting an image of a customized neon sign, comprising:
presenting at least one text selection control;
presenting at least one style selection control;
receiving text information from the text selection control;
receiving style selection information from the style selection control;
creating a sign image according to the received style selection information and including a neon-like representation of the received text information; and
presenting the created sign image.

2. The method of claim 1, wherein the text selection control is a text entry field.

3. The method of claim 2, wherein the style selection control is a style selection button.

4. The method of claim 2, wherein the image is created form overlaying a first image containing at least one feature of the neon sign on a second image, the second image containing at least one feature of the neon sign.

5. The method of claim 4, wherein one of the first image or second image includes multiple style features associated with a given style.

6. The method of claim 4, wherein at least one of the first image and second image includes at least one visual effect associated with neon tubing.

7. The method of claim 1, further comprising:
creating a halo image corresponding to the created sign image,
overlaying the halo image on the created sign image, and
presenting said created sign image with the overlay halo image.

8. The method of claim 1, further comprising:
creating a tube centerline image corresponding to the created sign image,
overlaying the tube centerline image on the created sign image, and
presenting said created sign image with the overlay tube centerline image.

9. The method of claim 1, further comprising:
creating a halo image corresponding to the created sign image,
overlaying the halo image on the created sign image,
creating a tube centerline image corresponding to the created sign image,
overlaying the tube centerline image on the created sign image, and
presenting said created sign image with the overlay halo image and tube centerline image.

10. A method of creating a neon image for display to a visitor to a web site, comprising:
receiving a sign image;
creating a halo image corresponding to the created sign image;
overlaying the halo image on the created sign image;
creating a tube centerline image corresponding to the created sign image; and
overlaying the tube centerline image on the created sign image.

11. The method of claim 10, wherein lines of the centerline tube image are of a color closer to white than the corresponding lines in the received sign image.

12. The method of claim 10, wherein the received sign image includes custom text entered by a visitor to a web site, and at least one style icon.

13. The method of claim 10, wherein the sign image includes a plurality of colored lines intended to correspond to neon tubes, and wherein the lines of the halo image correspond to the colored lines of the sign image

14. The method of claim 13, wherein the lines of the halo image have a color which is matched to create a dispersive effect of the color of the lines of the sign image.

15. A method of presenting a sign image for inspection to a visitor of a web site, comprising:
receiving text information from said visitor;
generating a neon effect image incorporating the received text image;
coupling the generated neon effect image incorporating the received text image with at least one neon sign image to create a customized neon sign image; and
presenting the customized neon sign image to the visitor.

16. The method of claim 15, further comprising:
presenting a plurality of neon sign style images to the visitor;
receiving a neon sign style selection; and
coupling the generated neon effect image incorporating the received text image with at least one neon sign image corresponding to the sign style selection to create a customized neon sign image; and
presenting the customized neon sign image to the visitor.

17. The method of claim 16, wherein at least two of the presented plurality of neon sign style images are customized neon sign images incorporating the received text.

18. The method of claim 15, wherein the received text information includes a first text string from a first text string entry field, and a second text string from a second text string entry field, and wherein generating the neon effect image incorporating the received text image includes:
incorporating the first text string at a first text string location; and
incorporating the first text string at a first text string location,
wherein the first text string location and the second text string location are defined by a style associated with at least one of the neon sign images.

19. The method of claim 15, further comprising:
retrieving neon sign price information;
calculating a price based upon the retrieving neon sign price information and the sign customization parameters; and
returning the calculated price to a potential customer.

20. The method of claim 15, wherein the received text information specifies a color for the received text.
